(19) United States
(12) Patent Application Publication
(10) Pub. No.: US 2015/0184809 A1
(43) Pub. Date: Jul. 2, 2015

(54) WARNING LIGHT DEVICE

(71) Applicant: LUMINOUS STAR TECHNOLOGY LTD., TAINAN CITY (TW)

(72) Inventor: TZU-FAN KUO, TAINAN CITY (TW)

(73) Assignee: LUMINOUS STAR TECHNOLOGY LTD., TAINAN CITY (TW)

(21) Appl. No.: 14/141,701

(22) Filed: Dec. 27, 2013

(51) Int. Cl. F21K 99/00; F21V 5/04

(52) U.S. Cl. CPC F21K 9/50; F21V 5/04; F21Y 2101/02

(57) ABSTRACT

A warning light device includes a base with multiple lighting members connected thereon. A cover is mounted to the base and accommodates the lighting members. An optical part unit is located between the lighting members and the cover, and has at least one first optical part and two second optical parts between which the first optical part is located. The lighting members are accommodated in the respective recesses of the first and second optical parts. Each of the two second optical parts has an expanding wall from the underside toward the top thereof. A slot is defined in the top of each of two second optical parts and each slot has a light-guide face. The light guide faces of the two second optical parts guide the light beams outward to provide a lager illumination area.

### BACKGROUND OF THE INVENTION

1. Fields of the invention

The present invention relates to a warning light device, and more particularly, to a warning light device providing a larger illumination area.

2. Descriptions of Related Art

The conventional warning light device is usually equipped on the vehicles of special tasks such as ambulances, fire trucks, police vehicles, engineering vehicles or rescue vehicles, or carried by the rescue persons such as traffic policemen, firefighters or mountain rescuers so as to provide sufficient illumination feature to proceed their jobs or tasks during nights, thick fog areas, emergency situations or natural disaster sites.

The conventional warning light devices use high-power lighting members which provide higher illumination function. However, the recent warning light devices use Light Emitting Diodes (LEDs) which have many advantages such as energy saving, the LEDs generate straight beams and cannot provide a wider and larger illumination area. If the LEDs are arranged toward different directions to improve the shortcomings mentioned above, there will be a lot of numbers of the LEDs needed which involve high cost, and power and heat removal will be problems too.

Taiwan Utility M341281 discloses an optical lamp cover assembly of a warning light device with lens positioning function, or M354129 discloses a warning light device which comprises a refraction member, a lighting member, a circuit board and a heat-removing plate. A cover covers the parts mentioned above and has wave-shaped face on the underside thereof. The inside of the cover is stepped shaped and protrusions are formed on the stepped portions. Positioning protrusions extend from the stepped portions of the cover. The refraction member has a wave-shaped end face which is matched with the wave-shaped face of the cover. The other end of the refraction member has a recess in which the lighting member is received. The lighting member is connected to the circuit board which is positioned by the protrusions of the cover. The heat-removing plate is located on the circuit board and has inclined engaging flanges which are engaged with the stepped portions and the protrusions. Nevertheless, the warning light device cannot provide a sufficient illumination area and meet the practical needs for a desired warning light device.

The present invention intends to provide a warning light device which improves the shortcomings mentioned above.

### SUMMARY OF THE INVENTION

The present invention relates to a warning light device and comprises a base having multiple lighting members connected thereon. A cover is mounted to the base and accommodates the lighting members. An optical part unit is located between the lighting members and the cover. The optical part unit has at least one first optical part and two second optical parts between which the first optical part is located. Each of the two second optical parts has a second recess defined in the underside thereof. The two lighting members located corresponding to the two respective second recesses are received in the two respective second recesses. Each of the two second optical parts has an expanding wall expanding from the underside toward the top thereof. A slot is defined in the top of each of two second optical parts. Each slot has a light-guide face.

Preferably, the cover has at least two bosses protruding from the inside thereof The at least one first optical part has two first notches and each of the two second optical parts has a second notch. The at least two bosses are engaged with the first and second notches.

Preferably, wherein the at least one first optical part has a first recess defined in the underside thereof. The lighting member located corresponding to the first recess of the at least one first optical part is received in the first recess of the first optical part.

Preferably, the top of each of the two second optical parts is shaped to be corresponding to the curvature of the inside of the cover.

Preferably, a fixing member is connected to the outside of the cover.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the warning light device of the present invention;

FIG. 2 shows an enlarged view of the second optical part of the warning light device of the present invention;

FIG. 3 shows another enlarged view of the second optical part of the warning light device of the present invention, and

FIG. 4 is a cross sectional view of the warning light device of the present invention.

### DETAILED DESCRIPTION OF THE PREFERRED EMBODIMENT

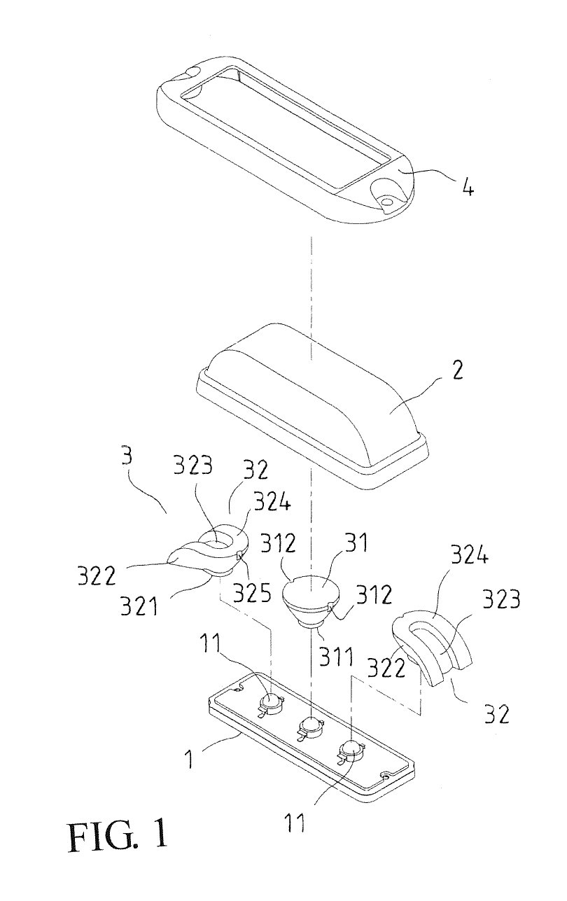

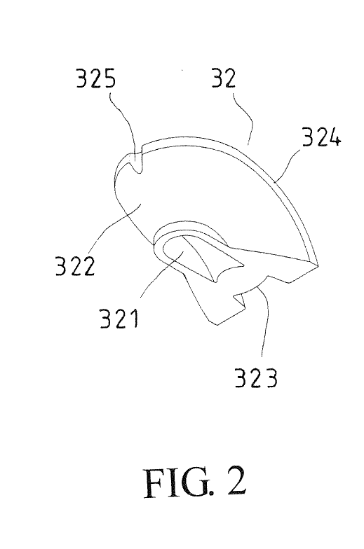

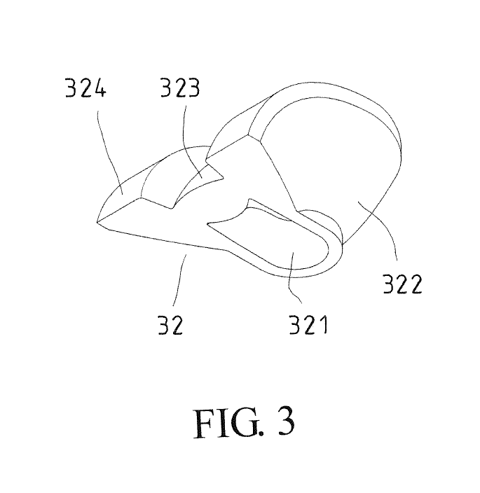

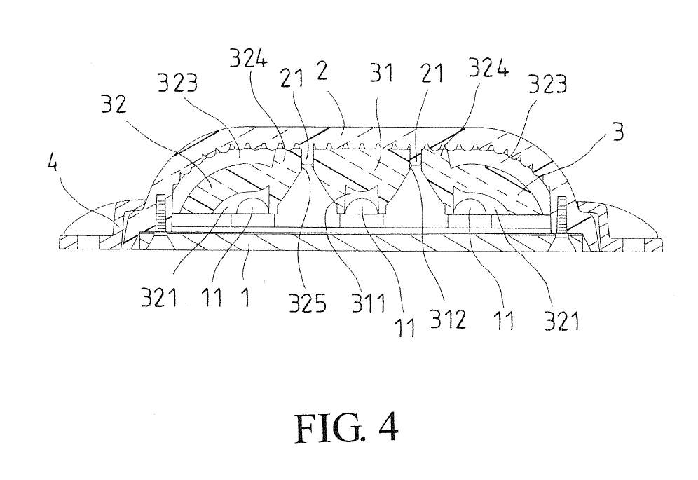

Referring to FIGS. 1 to 4, the warning light device of the present invention comprises a base 1 having multiple lighting members 11 connected thereon. A cover 2 is mounted to the base 1 and accommodates the lighting members 11. An optical part unit 3 is located between the lighting members 11 and the cover 2, and has at least one first optical part 31 and two second optical parts 32 between which the first optical part 31 is located. The at least one first optical part 31 has a first recess 311 defined in the underside thereof. The lighting member 11 located corresponding to the first recess 311 of the at least one first optical part 31 is received in the first recess 311 of the first optical part 31. Each of the two second optical parts 32 has a second recess 321 defined in the underside thereof. The two lighting members 11 located corresponding to the two respective second recesses 321 are received in the two respective second recesses 321. Each of the two second optical parts 32 has an expanding wall 322 expanding from the underside toward the top thereof. A slot 323 is defined in the top of each of two second optical parts 32, and each slot 323 has a light-guide face 324 as shown in FIGS. 2 and 3.

A fixing member 4 is connected to the outside of the cover 2. By the fixing member 4, the warning light device is positioned to the desired object or position.

When in assembling, the base 1 has a seat and a circuit board, the lighting members 11 are connected to the circuit board on the base 1. The first and second optical parts 31, 32 are mounted to the lighting members 11. In this embodiment, there are three lighting members 11. The two outermost lighting members 11 are located corresponding to the second recesses 321 of the second optical parts 32. The rest of the lighting members 11 are located corresponding to the first recess 311 of the first optical part 31.

The cover 2 is mounted to the base 1 and accommodates the lighting members 11. The top of each of the two second optical parts 32 is shaped to be corresponding to the curvature of the inside of the cover 2. The cover 2 has at least two bosses 21 protruding from an inside thereof. The at least one first optical part 31 has two first notches 312, and each of the two second optical parts 32 has a second notch 325. The at least two bosses 21 are engaged with the first and second notches 312, 325. By this way, the at least one first and the second optical parts 31, 32 are positioned within the cover 2. The fixing member 4 is connected to the outside of the cover 2 such that the warning light device is positioned to the desired object or position.

When in use, the light beams from the lighting members 11 pass through the first and second recesses 311, 321 of the first and second optical parts 31, 32. The at least one first optical part 31 is a cone-shaped optical lens and the tapered central portion of the cone-shaped optical lens diffuses the light beams out. The light-guide faces 324 of the slots 323 of the second optical parts 32 guide the light beams to form an annular light ring. Therefore, the warning light device has 180 degrees of illumination area which improves the shortcomings of the conventional warning light devices.

While we have shown and described the embodiment in accordance with the present invention, it should be clear to those skilled in the art that further embodiments may be made without departing from the scope of the present invention.

What is claimed is:

1. A warning light device comprising:
a base having multiple lighting members connected thereon;
a cover mounted to the base and accommodating the lighting members, and
an optical part unit located between the lighting members and the cover, the optical part unit having at least one first optical part and two second optical parts between which the first optical part is located, each of the two second optical parts having a second recess defined in an underside thereof, the two lighting members located corresponding to the two respective second recesses being received in the two respective second recesses, each of the two second optical parts having an expanding wall expanding from the underside toward a top thereof, a slot defined in the top of each of two second optical parts, each slot having a light-guide face.

2. The warning light device as claimed in claim 1, wherein the cover has at least two bosses protruding from an inside thereof, the at least one first optical part has two first notches and each of the two second optical parts has a second notch, the at least two bosses are engaged with the first and second notches.

3. The warning light device as claimed in claim 1, wherein the at least one first optical part has a first recess defined in an underside thereof, the lighting member located corresponding to the first recess of the at least one first optical part is received in the first recess of the first optical part.

4. The warning light device as claimed in claim 2, wherein the top of each of the two second optical parts is shaped to be corresponding to a curvature of the inside of the cover.

5. The warning light device as claimed in claim 2, wherein a fixing member is connected to an outside of the cover such that the warning light device is positioned to the desired object or position.
